(19) United States
(12) Patent Application Publication
(10) Pub. No.: US 2026/0233595 A1
(43) Pub. Date: Aug. 13, 2026

(54) TRANSMISSION DEVICE FOR A VEHICLE AXLE

(71) Applicant: Schaeffler Technologies AG & Co. KG, Herzogenaurach (DE)

(72) Inventor: Pierre-Gwénaël MESLOT, TOULOUSE (FR)

(21) Appl. No.: 19/155,009

(22) PCT Filed: Apr. 3, 2024
(86) PCT No.: PCT/EP2024/058983

§ 371 Date: Aug. 8, 2025

(30) Foreign Application Priority Data
Apr. 7, 2023 (FR) FR2303478

(51) Int. Cl. B60K 1/02; B60K 6/365; B60K 6/387; B60K 6/48; B60K 7/00; B60K 17/02; B60K 17/04; B60K 17/08; F16H 48/36

(52) U.S. Cl. CPC B60K 1/02; B60K 6/365; B60K 6/387; B60K 6/48; B60K 7/0007; B60K 17/02; B60K 17/046; B60K 17/08; F16H 48/36; B60K 2006/4825; B60K 2007/0061; B60Y 2200/92; F16H 2048/364

(57) ABSTRACT

A transmission device for a vehicle axle, comprising a first driving gear (11) intended to be driven by a first drive member M1, a second driving gear (12) intended to be driven by a second drive member (M2), a left wheel shaft (31), a right wheel shaft (32), a main axle shaft (10) interposed between the left and right wheel shafts, first left and right coupling members (41, 42) capable of selectively engaging the left and right wheel shafts (31, 32) respectively to rotate with the main axle shaft, two planet gears (21, 22), each planet gear being in permanent toothed engagement with the first driving gear (11) and with the second driving gear (12), and second left and right coupling members (51, 52) capable of selectively engaging the left and right wheel shafts (31, 32) respectively to rotate with the first driving gear (11) and with the second driving gear (12) respectively.

### DESCRIPTION

### Technical Field

The present invention relates to transmission devices for vehicle axles. It particularly relates to an axle having essentially electric propulsion. Such an axle can be suitable for a four-wheeled vehicle, although other applications are not excluded. One of the operating modes of the vehicle in question is so-called “off-road” mode, which involves traveling at very low speed on difficult terrain, passing over obstacles and/or ruts.

### Prior Art

W02021126333 discloses an axle having two electric motors, provided with a differential lock. It has been observed however that for very low-speed maneuvers in off-road mode, the electric motors involved run at very low speed (or are even locked), which causes a problem of overheating of the control circuits, and consequently has a detrimental impact on the performance and service life of the system.

The inventors have sought to propose a flexible, versatile solution for improving the behavior of the electrically propelled axle in off-road mode while allowing other operating modes, include on-road modes.

### Disclosure of the Invention

To this end, according to the present disclosure, a transmission device for a vehicle axle having an axle axis is proposed herein, the device comprising:
a first driving gear intended to be driven by a first drive member,
a second driving gear intended to be driven by a second drive member,
a left wheel shaft, intended to be coupled to a left axle wheel,
a right wheel shaft, intended to be coupled to a right axle wheel,
a main axle shaft, rotatably mounted about the axle axis and interposed between the left and right wheel shafts,
a first left coupling member capable of selectively engaging the left wheel shaft to rotate with the main axle shaft, directly or via a reducer,
a first right coupling member capable of selectively engaging the right wheel shaft to rotate with the main axle shaft, directly or via a reducer,
at least two planet gears, the main axle shaft acting as the planet carrier for the at least two planet gears, each of the at least two planet gears providing permanent toothed engagement with the first driving gear and the second driving gear,
a second left coupling member capable of selectively engaging the left wheel shaft to rotate with the first driving gear, directly or via a reducer,
a second right coupling member capable of selectively engaging the right wheel shaft to rotate with the second driving gear, directly or via a reducer.

By virtue of these arrangements, the first left coupling member and the first right coupling member make it possible to rigidly connect the left and right shafts and thus obtain the differential lock function on the axle, in particular for off-road situations. Furthermore, in an on-road situation, the left and right wheels can be driven independently by the left and right motors respectively, either conventionally or specifically with vectoring of the torque applied to the wheels. In addition, the axle can be placed in free wheel mode, to minimize drag, or in energy recovery mode in the context of regenerative electric braking. Moreover, the device disclosed enables a so-called “limp home” mode, in which drive can be obtained on both wheels even if one of the two motors has failed.

In short, the structure of the device, together with appropriate selective control of the four coupling members, provide general versatility and access to multiple operating modes of the axle.

It should be noted that the axle axis A is not necessarily coincident with the axis of the wheels. There can be a final reduction between the axle axis and the wheel axis that results in a wheel axis that is offset relative to the axle axis. There can also be a suspension connection to the ground with a relative vertical range of movement.

It will also be noted that in the above, the term “axle wheel” denotes the wheel of the vehicle in contact with the ground, while the term “driving gear” denotes a gear wheel in the axle mechanism.

In various embodiments of the invention, one or more of the following arrangements can optionally be used, taken individually or in combination.

R1a According to one aspect, each of the two planet gears is in permanent toothed engagement with both the first driving gear and the second driving gear. A structure similar to a bevel-gear differential is thus formed, with teeth inclined at 45° relative to the axis. However, a spur-gear structure is not excluded.

R2 According to one aspect, the first left coupling member and/or the first right coupling member can be a hydraulic clutch. Facing disks are pressed against each other by controlled hydraulic pressure, and there can be several pairs of disks interacting with each other. Such a hydraulic clutch can be controlled to permit a degree of slip between the two respective rotating parts.

R2b According to another aspect, the first left coupling member and/or the first right coupling member can be a mechanical dog clutch system, for example with an axially movable splined sleeve. This forms a solution free of losses, with excellent efficiency.

R3 According to one aspect, the second left coupling member and/or the second right coupling member can be a hydraulic clutch. Again, these can be disks arranged facing each other and pressed against each other by controlled hydraulic pressure. Again, such a hydraulic clutch can in some cases be controlled to permit a degree of slip between the two respective rotating parts.

R3b According to another aspect, the second left coupling member and/or the second right coupling member can be a mechanical dog clutch system, for example with an axially movable splined sleeve.

R4 According to one aspect, the speed of rotation (V10) of the main axle shaft is the algebraic half-sum of the speed of rotation (V11) of the first driving gear and the speed of rotation (V12) of the second driving gear. If the first driving gear and the second driving gear rotate in the same direction, and at the same speed, then the main axle shaft also rotates at the same speed. If the first driving gear and the second driving gear rotate in opposite directions and at the same speed, then their effects cancel each other out and the main axle shaft does not rotate (zero speed of rotation); advantage is taken of this feature for almost stationary or very low-speed situations in off-road mode. Using the notations above, the speeds of rotation satisfy the equation V10=(V11+V12)/2.

R5 According to one aspect, for a trail/off-road mode, with the first left and right coupling members engaged (with the axle differential lock function present), and with a speed of the main axle shaft below a first predetermined threshold SV1, the speed of rotation (V11) of the first driving gear and the speed of rotation (V12) of the second driving gear are each greater, as an absolute value, than a second predetermined threshold SV2, and SV2>SV1. By virtue of the device disclosed, rotation speeds can be selected for each of the two motors that are sufficiently different from zero, for an output shaft speed close to zero. This avoids any risk of overheating of the electronic control stages of the motors and any possible derating (intentional reduction in performance in order to protect the equipment).

R6 According to one aspect, when the four coupling members are in the uncoupled state (clutch open), the right and left wheels are in a free wheel configuration. This minimizes the drag introduced by the presence of the axle, in its state without drive. This mode is advantageous for freeway driving for example, and promotes energy saving for travel.

R7 According to one aspect, the first driving gear and the second driving gear are rotatably mounted about the axle axis, and the first driving gear and the second driving gear are positioned symmetrically on either side of an axle mid-plane. The torque called into play is thus naturally balanced, promoting the right-left balance of the assembly.

R8 According to one aspect, the device can further include the first drive member and the second drive member, the first and second drive members being electric motors. The axle forms a standalone motorized assembly, with a power supply and local or remote electronic control.

R8b According to one aspect, the use of hydraulic motors instead of the electric motors is not excluded.

R9 According to one aspect, each of the first and second drive members has a rotor having an axis coincident with the axle axis (A). This improves the incorporation of the motors into the axle and improves the general compactness of the solution.

R10 According to one aspect, the main axle shaft can be constrained to rotate with an auxiliary gear wheel that can be driven selectively by a longitudinal shaft of the vehicle from another axle or from an auxiliary electric or combustion drive member. The proposed axle can thus be suitable for numerous applications on vehicles having two or more axles.

R11 According to one aspect, for a left side (or right side respectively), a planetary gear set can be interposed between the first and second coupling members (41, 51) and the wheel shaft.

R11b According to one aspect, the planetary gear set is a Ravigneaux gear set.

### DESCRIPTION OF THE DRAWINGS

Other features and advantages of the invention will also become apparent on reading the following description. This is purely illustrative and should be read in conjunction with the appended drawings, in which:

FIG. 1 schematically illustrates an electrically propelled axle according to a first embodiment of the present invention,

FIG. 2 schematically illustrates an on-road operating mode with independent drive controls applied to the wheels,

FIG. 3 schematically illustrates another operating mode with vectoring of the drive controls applied to the wheels,

FIG. 4 schematically illustrates another on-road operating mode with a free wheel function on the axle,

FIG. 5 schematically illustrates another operating mode in a situation in which one of the drive members has failed,

FIG. 6 schematically illustrates another so-called trail or off-road operating mode,

FIG. 7 schematically illustrates an electrically propelled axle according to a second embodiment of the present invention,

FIG. 8 schematically illustrates an electrically propelled half-axle according to a third embodiment of the present invention,

FIG. 9 shows a detailed view of a planetary gear set interposed between the first and second coupling members and the wheel shaft, useful in particular in the third and fourth embodiments,

FIG. 10 schematically illustrates an electrically propelled half-axle according to a fourth embodiment of the present invention.

### DESCRIPTION OF THE EMBODIMENTS

In the various figures, the same reference signs denote identical or similar components. For reasons of clarity of the description, some elements are not necessarily shown to scale.

In addition, it should be noted that in order to make the figures easier to read, the axle housing is not shown in the figures. Likewise, the lubrication system is not shown. With regard to the bearings, the various ball or roller bearings usually used are not shown, apart from some shown symbolically in dashed lines. Likewise, it should be noted that a suspension and/or steering mechanism can be provided on the wheels that is not shown in the figures but is compatible with the present disclosure.

The figures show an electrically propelled axle. In the example illustrated, this electrically propelled axle comprises at least two electric motors. However, it could be provided with more than two electric motors.

In an alternative embodiment, hydraulic motors can be used instead of electric motors. The generic term “drive member” can thus be used to denote an electric motor or a hydraulic motor equally.

This axle can be suitable for a four-wheeled vehicle, although other applications are not excluded, for example three-wheeled vehicles or vehicles having more than four wheels. In the vehicle in question, there can be another axle of the same type or an axle of a different type with combustion or hybrid propulsion for example. Likewise, the use of the proposed axle in a vehicle having more than two axles is not excluded.

### Structure

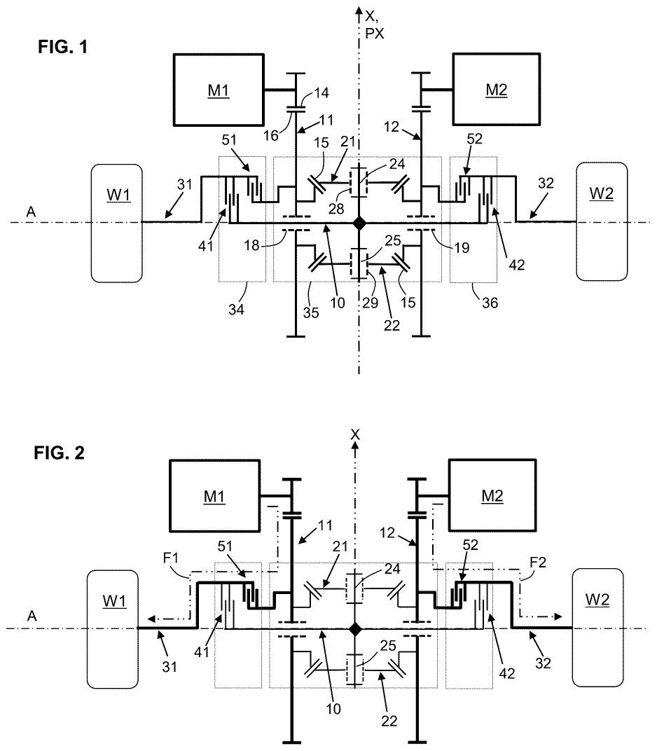

With reference to FIG. 1, the axle is organized around an axle axis denoted A, generally perpendicular to a longitudinal axis X of the vehicle borne by the axle. A left wheel W1 and a right wheel W2 are mounted on the axle in question and most of the time are in contact with the ground, but one of them can also sometimes be raised relative to the ground, in particular in off-road conditions when passing over obstacles or passing over ruts. The example illustrated relates to an axle with non-steering wheels, but the solution disclosed can also apply to an axle with steering wheels. Likewise, the suspension of the axle can be independent or non-independent wheel suspension.

The axle receives driving power from a first drive member M1 and a second drive member M2. With regard to the drive member, it is for example preferably an electric machine, for example a brushless electric motor. Depending on the control logic of the poles of the motor, the electric machine can be a motor or the electric machine can be a generator, in which case energy recovery mode is activated.

The axle comprises a first driving gear 11 (for example the wheel situated on the left) engaged with an output pinion of the first drive member M1 and a second driving gear 12 (for example the wheel situated on the right) engaged with an output pinion of the second drive member M2. In FIG. 1, the teeth 14, 16 on the drive member side and the driving gear side respectively are shown.

In the example illustrated, the first driving gear 11, with its drive member M1, is symmetrical with the second driving gear 12, with its drive member M2, relative to a mid-line of the vehicle denoted PX. Depending on the possible incorporation of the axle in the vehicle, the configuration could of course be asymmetrical.

The axle comprises a main axle shaft 10 that is rotatably mounted about the axle axis A and generally interposed between the left and right wheel shafts. The main axle shaft 10 comprises a cylindrical axial portion extending essentially along the axis, and can be supplemented by auxiliary elements described hereinafter.

The axle comprises at least two planet gears (reference signs 21 and 22). Each planet gear is in permanent toothed engagement with both the first driving gear 11 and the second driving gear 12. In the example illustrated, the teeth 15 are oriented at 45° relative to the axle axis A. The configuration thus defined resembles a bevel-gear differential, but with the difference that the assembly is reversed. Here, the output of the system is the planet carrier, unlike in a differential on a conventional axle.

The main axle shaft 10 comprises two diametrically opposed radial supports 24, 25. The radial supports 24, 25 are rigidly mounted relative to the axial portion of the main axle shaft 10.

A planet gear is mounted on each of these radial supports. The main axle shaft 10 thus acts as a planet carrier for the two planet gears 21, 22.

A spur-gear differential assembly could be used instead of a bevel-gear differential assembly. The technical feature can thus be generalized by stating that each of the two planet gears 21, 22 participates in permanent toothed engagement with the first driving gear 11 and with the second driving gear 12.

It will be noted that the number of planet gears can be greater than two.

The axle comprises a left wheel shaft 31 coupled to the left axle wheel W1 and a right axle shaft 32 coupled to the right axle wheel W2. In the first embodiment illustrated in FIGS. 1 to 6, the left wheel shaft 31 and the right wheel shaft 32 are respectively coupled directly to the left axle wheel and the right axle wheel respectively. It will be seen hereinafter that a reducer or a gear mechanism can be interposed in this location. However, as mentioned previously, there can be at least one universal joint at the interface with the wheel for a suspension function or for a steering function.

Furthermore, the axle comprises a first left coupling member 41 capable of selectively engaging the left wheel shaft 31 for rotation about the axle axis A with the main axle shaft 10. In the first embodiment, the engagement of the left wheel shaft 31 with the main axle shaft 10 via the first left coupling member 41 is directly, without any intermediate elements. It will be seen hereinafter that the coupling in question can take place via a reducer or a gear set.

Furthermore and similarly, the axle comprises a first right coupling member 42 capable of selectively engaging the right wheel shaft 32 for rotation about the axle axis A with the main axle shaft 10. The coupling can take place directly as illustrated in the first embodiment, or via a reducer or a gear set as discussed hereinafter.

In the example illustrated, the first coupling member (left 41 or right 42) is a hydraulic clutch. Facing disks are pressed against each other by controlled hydraulic pressure. There can be a pair of disks (single-disk clutch) or several pairs of disks interacting with each other (multi-disk clutch). Such a hydraulic clutch can be controlled by hydraulic pressure regulated to permit a degree of slip between the two respective rotating parts.

In one alternative embodiment, the first coupling member (left or right) can be a mechanical dog clutch system, for example with an axially movable splined sleeve.

In addition, the axle comprises a second left coupling member 51 capable of selectively engaging the left wheel shaft 31 for rotation about the axle axis A with the first driving gear 11. The coupling can take place directly or via a reducer or a gear set.

In addition, the axle comprises a second right coupling member 52 capable of selectively engaging the right wheel shaft 32 for rotation about the axle axis A with the second driving gear 12. The coupling can take place directly or via a reducer or a gear set.

In the example illustrated, the second coupling member (left 51 or right 52) is a hydraulic clutch, for example a single-disk clutch or a multi-disk clutch, as mentioned above. Here again, the hydraulic clutch can be controlled by hydraulic pressure regulated to permit a degree of slip between the two respective rotating parts.

In one alternative embodiment, the second coupling member (left or right) can be a mechanical dog clutch system, for example with an axially movable splined sleeve.

The left coupling members 41, 51 are housed in a left clutch housing 34. The right coupling members 42, 52 are housed in a right clutch housing 36.

### Operation

FIGS. 2 to 6 illustrate different operating modes of the proposed transmission device. The parts shown in bold lines are the deployed parts of the system, while the parts shown in fine lines are not deployed.

The central assembly 35 with the planet gears 21, 22 means that the speed of rotation of the main axle shaft 10 is the algebraic half-sum of the speed of rotation of the first driving gear 11 and the speed of rotation of the second driving gear 12. In other words, if the speed of rotation of the main axis shaft 10 is denoted V10, the speed of rotation of the first driving gear 11 is denoted V11, and the speed of rotation of the second driving gear 12 is denoted V12, then V10 =(V11+V12)/2. The speed values are signed values: by convention, a positive speed of rotation is taken as contributing to moving the vehicle forward, and a negative speed of rotation is taken as contributing to moving the vehicle backward.

FIG. 2 illustrates the scenario of independent drive control applied to the left wheel and the right wheel respectively. The transmission of torque follows the arrows F1, F2 shown in chain dotted lines in FIG. 2.

The first left coupling member 41 and the first right coupling member 42 are in the inactive state, that is, the clutch is open.

The second left coupling member 51 is in the active state, that is, it constrains the first driving gear 11 to rotate with the left wheel shaft 31. Here, the configuration corresponds to a closed clutch, without slip.

The second right coupling member 52 is in the active state, that is, it constrains the second driving gear 12 to rotate with the right wheel shaft 32. Here again, the configuration corresponds to a closed clutch, without slip.

If the speeds of the wheels W1, W2 are not identical, the planet gears 21, 22 can rotate freely on themselves, which permits a speed difference between the first driving gear 11 and the second driving gear 12. The main axle shaft 10 rotates as a function of the rotation of the planet gears. The above-mentioned situation corresponds to conventional cornering on an on-road route with the outer wheel covering more distance. Conversely, if the speeds of the wheels W1, W2 are identical, the main axle shaft 10 does not rotate (straight line situation).

In this mode, the electric motors can thus work in regenerative mode, whether in a downhill driving scenario, or during deceleration, or even in the event of active electric braking.

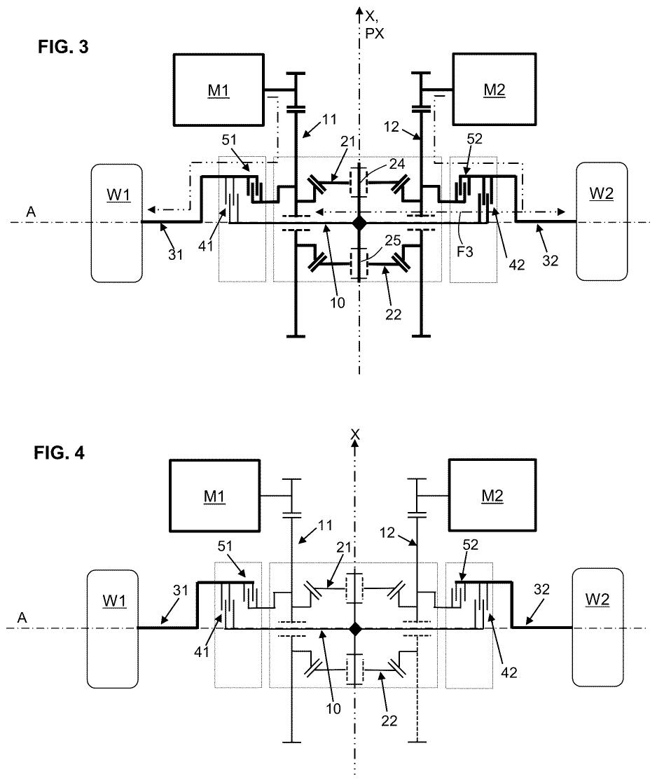

FIG. 3 illustrates an operating mode with vectoring of the drive torque applied to the wheels. As in the preceding case in FIG. 2, the second left coupling member 51 is in the active/closed state and the second right coupling member 52 is in the active/closed state. However, unlike in FIG. 2, the first right coupling member 42 is partially closed, and as a result the main axle shaft 10 is driven from the second drive member via the second right coupling member 52 and the first right coupling member 42.

Some of the torque generated by the second electric motor M2 is thus directed toward the planet carrier of the central differential and the planet gears 21, 22 transmit this torque to the left wheel W1, this torque being added to (or subtracted from) the torque generated by the first electric motor. This is illustrated by a chain dotted arrow F3 in FIG. 3. This vectoring mode can also be applied in the event of energy recovery (deceleration or braking).

It will be noted here that the control of the electric motors can obey a torque control logic or a speed control logic. A scenario in which one of the motors is controlled with respect to torque and the other motor is controlled with respect to speed is in particular used in the case of vectoring of the torque transmitted or received. The slip of the first right coupling member 42 can be controlled from a control unit (not shown), for example in order to contribute to the anti-skid function.

FIG. 4 illustrates a free wheel operating mode, or in other words a drag minimizing mode. The four coupling members 41, 42, 51, 52 are in the open state, and the right and left wheels W1, W2 are in a free wheel configuration. This minimizes the drag introduced by the presence of the axle, in its state without drive. This mode is preferred in medium or high-speed range situations (highway and freeway).

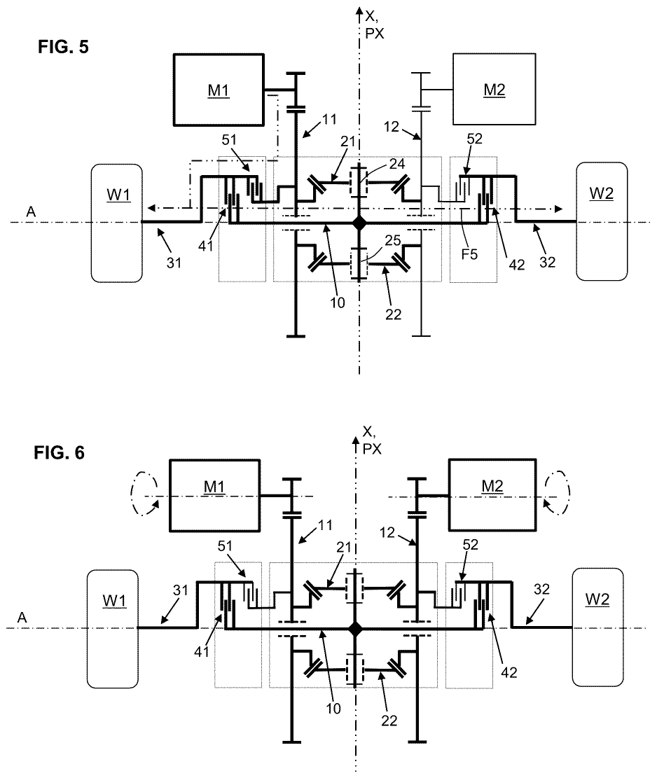

FIG. 5 illustrates an operating mode in a situation in which one of the drive members has failed, here for example the motor M2. M2 is no longer producing drive or resisting torque.

The second left coupling member 51 is in the active/closed state, without slip.

The first left coupling member 41 is in the active state, that is, it constrains the main axle shaft 10 to rotate with the left wheel shaft 31.

The first right coupling member 42 is in the active state, that is, it constrains the main axle shaft 10 to rotate with the right wheel shaft 32.

The path of the torque in order to drive the right wheel W2 from the first motor M1 is illustrated by a chain dotted arrow F5 in FIG. 5.

The first right coupling member 42 is controlled to permit a degree of slip and permit a speed difference between the left and right wheels.

FIG. 6 illustrates so-called trail or off-road operation.

The second left coupling member 51 and the second right coupling member 52 are in the inactive state, that is, the clutch is open.

The first left coupling member 41 is in the active state, that is, it constrains the main axle shaft 10 to rotate with the left wheel shaft 31. Here, the configuration corresponds to a closed clutch, without slip.

The first right coupling member 42 is in the active state, that is, it constrains the main axle shaft 10 to rotate with the right wheel shaft 32. Here again, the configuration corresponds to a closed clutch, without slip.

The axle differential lock function is thus performed by the closed clutches 41, 42.

In this mode, the wheels of the vehicle are not rotating quickly; in most cases, the speed is very low, or the vehicle is even almost stationary. The speed of rotation of the main axle shaft 10 is thus low or even zero.

It is advantageous to select rotation speeds for each of the two motors that are sufficiently different from zero in order to avoid the overheating of the electronic power control circuits of the motors M1, M2.

We have seen that V10=(V11+V12)/2. It will be recalled that V11 and V12 are signed values, generally of opposite sign in this mode.

In off-road mode, travel is at very low speed on difficult terrain, passing over obstacles and/or ruts, or on slippery or muddy terrain. The speed of the main axle shaft V10 is very low.

Advantageously, the first motor M1 is controlled to rotate in a first direction and the second motor M2 is controlled to rotate in the opposite direction. For example, V11 can be selected between 100 rpm and 500 rpm and V12=−V11 as signed values.

As a result, for a speed of the main axle shaft 10 below a first predetermined threshold SV1, the speed of rotation V11 of the first driving gear 11 and the speed of rotation V12 of the second driving gear 12 are each, as an absolute value, greater than a second predetermined threshold SV2, with SV2>SV1.

For example, SV1 can be selected as 10 rpm, and SV2 as 30 rpm.

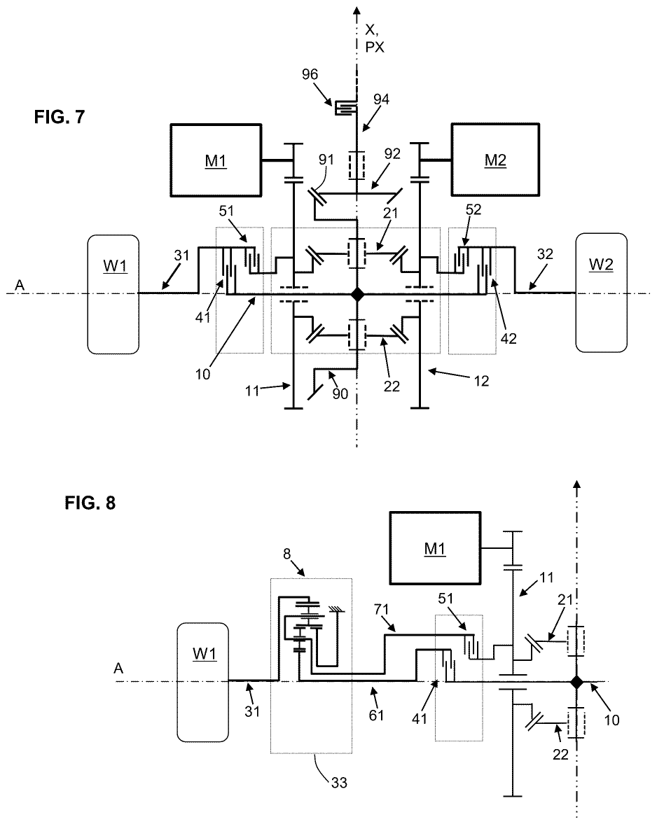

According to a second embodiment, illustrated in FIG. 7, the proposed transmission device can be coupled via a shaft aligned with the longitudinal axis of the vehicle to another axle of the vehicle.

More specifically, the radial supports 24, 25 rigidly connected to the main axle shaft 10 also bear a ring gear 90 provided with bevel gear teeth 91 at 45°. This ring gear 90 is meshed with a bevel pinion 92 mounted on a longitudinal shaft 94 having an axis of rotation parallel to or coincident with the longitudinal axis X of the vehicle. Moreover, a clutch 96 is provided to selectively couple or uncouple the two axles.

The remaining elements of the second embodiment that are not specifically described are considered to be identical or similar to the elements of the first embodiment.

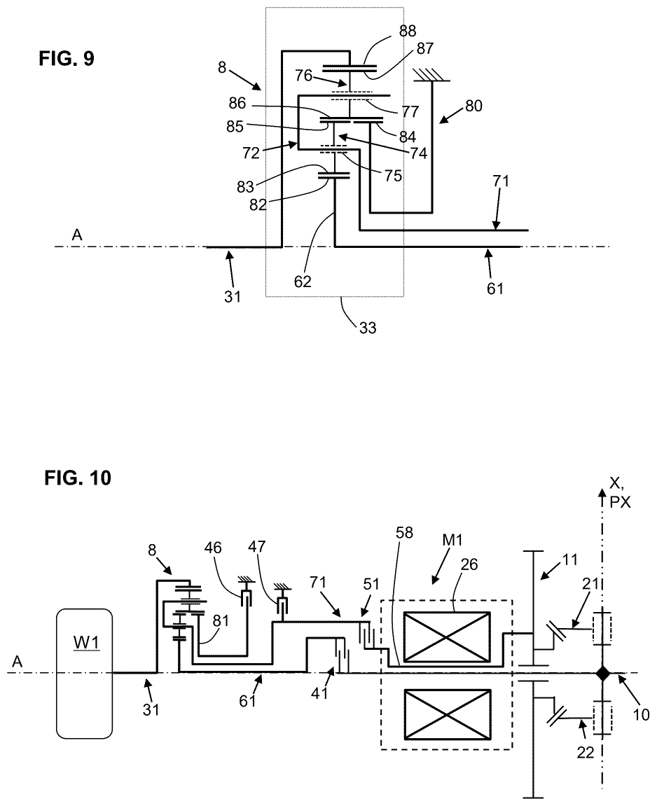

According to a third embodiment, illustrated in FIG. 8, the proposed transmission device comprises a planetary gear set 8 interposed between the first and second coupling members (41, 51) and the wheel shaft. Only the left part of the axle is shown in FIG. 8. FIG. 9 illustrates the planetary gear set 8 illustrated in FIG. 8 in greater detail.

In this configuration, a first intermediate shaft 61 and a second intermediate shaft 71 are provided. The first intermediate shaft 61 is connected on the central side to the first left coupling member 41, and on the wheel side bears the sun gear 62 of the planetary gear set 8.

The second intermediate shaft 71 is connected on the central side to the second left coupling member 51, and on the wheel side acts as a planet carrier for two sets of planet gears 74, 76 of the planetary gear set 8.

In the compound planetary gear set, the second intermediate shaft is constrained to rotate with a planet carrier part that forms a bearing 75 for the first planet gear 74 and a second bearing 77 for a second planet gear 76. The first planet gear 74 is in permanent toothed engagement 85, 86 with the second planet gear 76. The first planet gear is also permanently engaged with the sun gear 62 via the teeth 82, 83.

The wheel shaft 31 is rigidly connected to, or bears, an outer ring gear with radially inner teeth 88. The teeth 87 of the second planet gear 76 are engaged, on the outer side, with the aforementioned radially inner teeth 88. Finally, the second planet gear 76 is engaged, on the inner side, with a gear wheel 80, here fixed relative to the housing of the axle, by mutual engagement of the teeth 84, 86.

The compound planetary gear set 8 illustrated here is known in the art as a Ravigneaux gear set. In the third embodiment, it operates as a reducer.

The remaining elements of the third embodiment that are not specifically described are considered to be identical or similar to the elements of the first embodiment.

According to a fourth embodiment, illustrated in FIG. 10, the transmission device includes the motors as part of a mechanical incorporation approach.

Only the left part of the axle is shown. The motor M1 is arranged between the central differential, in particular the driving gear 11, and the first and second left coupling members 41, 51.

The coils 26 of the motor are arranged circumferentially with an axis coincident with the axle axis A.

The rotor of the motor is constrained to rotate with a tubular shaft 58 that passes through the motor M1. The tubular shaft 58 is connected on the central side to the driving gear 11, and is connected on the opposite side to the second coupling member 51.

Moreover, the kinematic system can be supplemented by two auxiliary clutches that provide a gearbox function. A first auxiliary clutch 47 (for example a band brake) makes it possible to rotatably immobilize the second intermediate shaft 71. A second auxiliary clutch 46 (for example a band brake) rotatably immobilizes or releases the gear wheel bearing the teeth 84.

The Ravigneaux gear set operates in this third embodiment as a gear selector, e.g. a reducer or multiplier.

A control unit is provided to control the two electric motors and the state of the coupling members or clutches. The power control of the motors can be incorporated into the control unit or can be on each of the motors M1, M2 respectively.

1. A transmission device for a vehicle axle having an axle axis (A), the device comprising:
a first driving gear (11) intended to be driven by a first drive member (M1),
a second driving gear (12) intended to be driven by a second drive member (M2),
a left wheel shaft (31), intended to be coupled to a left axle wheel (W1),
a right wheel shaft (32), intended to be coupled to a right axle wheel (W2),
at least two planet gears (21, 22),
a second left coupling member (51) capable of selectively engaging the left wheel shaft (31) to rotate with the first driving gear (11), directly or via a reducer,
a second right coupling member (52) capable of selectively engaging the right wheel shaft (32) to rotate with the second driving gear (12), directly or via a reducer, the device being configured so that it comprises:
a main axle shaft (10), rotatably mounted about the axle axis (A) and interposed between the left and right wheel shafts (31, 32),
a first left coupling member (41) capable of selectively engaging the left wheel shaft (31) to rotate with the main axle shaft (10), directly or via a reducer,
a first right coupling member (42) capable of selectively engaging the right wheel shaft (32) to rotate with the main axle shaft (10), directly or via a reducer,
and wherein the main axle shaft (10) acts as a planet carrier for the at least two planet gears (21, 22), each of the at least two planet gears (21, 22) providing permanent toothed engagement with the first driving gear (11) and the second driving gear (12).

2. The device as claimed in claim 1, wherein the first left coupling member (41) and/or the first right coupling member (42) is a hydraulic clutch.

3. The device as claimed in claim 1, wherein the second left coupling member (51) and/or the second right coupling member (52) is a hydraulic clutch.

4. The device as claimed in claim 1, wherein the speed of rotation of the main axle shaft (10) is the algebraic half-sum of the speed of rotation of the first driving gear (11) and the speed of rotation of the second driving gear (12).

5. The device as claimed in claim 4, wherein for a trail/off-road mode, with the first left and right coupling members (41, 42) engaged, and with a speed of the main axle shaft (10) below a first predetermined threshold (SV1), the speed of rotation (V11) of the first driving gear (11) and the speed of rotation (V12) of the second driving gear (12) are each greater than a second predetermined threshold (SV2), and SV2>SV1.

6. The device as claimed in claim 1, wherein when the four coupling members are in the uncoupled state, the right and left wheels are in a free wheel configuration.

7. The device as claimed in claim 1, wherein the first driving gear (11) and the second driving gear (12) are rotatably mounted about the axle axis (A) and the first driving gear (11) and the second driving gear (12) are positioned symmetrically on either side of an axle mid-plane (PX).

8. The device as claimed in-any claim 1, further including the first drive member (M1) and the second drive member (M2), the first and second drive members (M1, M2) being electric motors.

9. The device as claimed in claim 8, wherein each of the first and second drive members (M1, M2) has a rotor having an axis coincident with the axle axis (A).

10. The device as claimed in claim 1, wherein the main axle shaft (10) is constrained to rotate with an auxiliary gear wheel (90) that can be driven selectively by a longitudinal shaft (94) of the vehicle from another axle or from an auxiliary electric or combustion drive member.
